(19) United States
(12) Patent Application Publication
(10) Pub. No.: US 2011/0284338 A1
(43) Pub. Date: Nov. 24, 2011

(54) Arrestor

(75) Inventor: Steven Corcoran, Cawood (GB)

(73) Assignee: CORCOST LIMITED, Cawood (GB)

(21) Appl. No.: 13/145,243

(22) PCT Filed: Feb. 12, 2010
(86) PCT No.: PCT/GB2010/000255

§ 371 Date: Jul. 19, 2011

(30) Foreign Application Priority Data
Feb. 16, 2009 (GB) 0902436.5
Feb. 16, 2009 (GB) 0902445.6
Feb. 16, 2009 (GB) 0902446.4
Feb. 16, 2009 (GB) 0902448.0
Feb. 17, 2009 (GB) 0902618.8

(51) Int. Cl. F16D 11/14

(52) U.S. Cl. 192/69.6

(57) ABSTRACT

A system having a rotary output, including a drive shaft, a pin coupled to the drive shaft and an output shaft coupled to the drive shaft. A guideway is associated with the output shaft. Rotation of the drive shaft results in rotation of the output shaft and the guideway and movement of the pin along a pin path. The system is prevented from providing a rotary output when the pin abuts against a sidewall of the guideway, but permitted to provide a rotary output when the portion of the guideway aligned with the pin path corresponds with the position of the pin.

### BACKGROUND OF THE INVENTION

Rotating systems have been used for many years and can be applied to a wide range of situations. In general, rotating systems comprise a rotating drive component, a rotating output component and a transmission means for providing transmission between the drive component and the output component. The transmission means can be arranged to convert and/or modify the motion of the drive component and apply that modified motion to the output component depending upon what output is desired.

Various fail-safe mechanisms have been proposed to prevent a rotating system from rotating under certain conditions.

For example, a ratchet arrangement can be used to prevent a system from rotating in a backwards direction. Ratchet arrangements generally consist of a circular rotating gear having a rack of teeth running around its circumference and a pivoting finger that engages with the teeth. The teeth are shaped to have a steep side and a gently sloping side such that when the gear rotates in a forward direction, the finger will pivot and pass over the gently sloping side of the teeth without inhibiting the rotation of the gear. However, if the gear was to begin rotate in a backwards direction, the pivoting finger would engage with the steep sides of the teeth and prevent the gear from rotating in that backwards direction.

Therefore, ratchet arrangements can prevent rotation in one direction, but not in the other. Furthermore, because the teeth of the gear are spaced apart, the finger can only engage the ratchet at discrete points and therefore the ratchet can only stop rotation in the backward direction at discrete points. Therefore there may still be some backwards movement of the gear before the ratchet can bring the gear to a complete stop.

Further still, ratchet arrangements can be unreliable. For example, there can be instances in which the gear will rotate in the backwards direction without the finger engaging with the teeth. This can occur if the backwards motion commenced when the finger was at a raised position with respect to the teeth of the gear such that it becomes stuck or jammed in the raised position whilst the gear rotates backwards and hence unable to engage with the gear.

Various types of braking mechanisms have also been proposed to bring a rotating system to a stop by applying a frictional force to the rotating device. For example, an actuator may be used to tighten a metal component, which runs around a rotating drum in the event of a failure in the rotation of the drum. Alternatively, a disc brake may be located on a rotating shaft and a calliper may be used to provide friction to the disc to slow and eventually stop the shaft from rotating. However, such friction based braking systems require control systems to activate the braking means when a sensor has detected a reason why the rotating system should be prevented from rotating. Furthermore, for such braking systems, there is often a delay between the braking means being activated and the rotating body coming to a complete stop.

### SUMMARY OF THE INVENTION

According to the present invention, there is provided a system having a rotary output, the system comprising:
a drive shaft;
an arrestor path coupling a pin to the drive shaft such that rotation of the drive shaft results in movement of the pin along a pin path;
an output shaft providing output from the system or coupled to a shaft which provides output from the system, the output shaft associated with a guideway arranged such that rotation of the output shaft aligns a different portion of the guideway with the pin path; and
a transmission path coupling the drive shaft to the output shaft such that rotation of the drive shaft results in rotation of the output shaft;
wherein when the movement of the pin is synchronised with the rotation of the output shaft, the portion of the guideway aligned with the pin path corresponds with the position of the pin, for any given rotation of the drive component;
wherein when the movement of the pin is not synchronised with the rotation of the output shaft, the portion of the guideway aligned with the pin path will not correspond with the position of the pin such that the pin will abut against the sidewall of the guideway to limit the further rotation of the output shaft.

It is generally desirable for rotating systems to provide precise and consistent outputs of rotation. Therefore, since the output shaft is coupled to the drive shaft, it is generally desirable that the rotation of the drive shaft and the rotation of the output shaft remain consistent with respect to one another. However, over time, failures can occur in the system such that it no longer provides a desired output rotation. For example, a catastrophic failure could occur in the system such that the coupling between the drive shaft and the output shaft is completely severed. In such a scenario, the output shaft would be free to rotate or “free wheel” and would no longer be dependent upon the rotation of the drive shaft.

Alternatively, failure in the system could occur due to the components becoming damaged and/or worn and no longer functioning as expected. Such damage and/or wear can affect the relationship between the rotation of the drive shaft and the rotation of the output shaft, and can therefore result in discrepancies occurring between the actual output provided by the system and the output which would normally be expected.

In both cases such a failure may be undesirable. For example, where the rotating system is being used to raise or lower objects which are fragile and/or valuable, sudden movement of the objects by an unexpected/undesired amount could result in damage of the objects. In addition, if a catastrophic failure occurs during raising or lowering of an object, the output shaft will be free to rotate, therefore allowing any objects to freely fall.

For similar reasons, such failure would be undesirable where the system is being used to raise or lower persons, for example, hospital patients. Here, sudden undesired/unexpected movement of the patients will be undesirable since this could result in further injury or pain to the patient.

The present invention prevents a rotating system from outputting in the event of such failures occurring by providing a system which permits the rotation of the output shaft when functioning correctly but which prevents the rotating system rotating and providing output when a failure occurs within the system.

The present invention provides a system providing rotary output when the movement of the pin is synchronised with the rotation of the output shaft but which will be prevented from providing a rotary output in the event of a failure as the pin will not move along the guideway as the movement of the pin will not be synchronised with the rotation of the output shaft resulting in the system not providing an output due to the abutment of the pin against the sidewall of the guideway. Therefore, the present invention provides a rotary system with a system which can prevent rotary output when there is a failure in the rotary system such that it would not be providing a desired/expected output.

Preferably, the rotation of the drive shaft results in proportional movement of the pin and proportional rotation of the output shaft.

Preferably the arrestor path is provided with a self-locking means. In this case, the arrestor path has an input coupled to the drive shaft and an output coupled to the pin. Application of force to the pin does not result in movement of the pin due to its coupling with the output end of the arrester path, and therefore does not result in movement of the output shaft. This ensures that in the absence of drive to the input of the arrestor path, the pin will not move and therefore the output shaft will not rotate. Alternatively or additionally, the transmission path could be provided with a self-locking means.

Where the arrestor path is provided with a self-locking means, it is preferred that the self-locking means includes a leadscrew which is directly or indirectly threadingly engaged with the pin such that rotation of the leadscrew results in movement of the pin along the pin path. The application of force to the pin will not cause the leadscrew to rotate and so the pin will self-lock and not move. The self-locking means may instead be a worm drive or any other suitable self-locking device.

Preferably the guideway is a channel in the output shaft. The channel may be a through channel which projects completely through the output shaft. Alternatively, the channel may be a blind channel which projects partially into the output shaft. In either case, when the movement of the pin is not synchronised with the rotation of the output shaft, the pin will abut against a side wall of the channel to limit the further rotation of the output shaft.

The guideway may comprise one or more projections from the surface of the output shaft. In this case, when the movement of the pin is not synchronised with the rotation of the output shaft, the pin will abut against a side of the one or more projections to limit the further rotation of the output shaft.

Where the guideway is a through channel in the output shaft, it is preferred that the pin projects completely through and beyond the channel in the output shaft. This allows the movement of the pin along the pin path to be controlled at both ends of the pin.

Preferably, the pin projects into/through a guide which is generally aligned with the pin path. The guide is fixed with respect to the pin path and may be integral with a casing housing the system. The guide acts to guide the pin along its pin path, as well as helping to prevent the pin from being moved out of the pin path, for example due to rotation of the output shaft. More specifically, where the output shaft is rotating but is not synchronised with the movement of the pin the side walls of the guideway of the output shaft will abut against the pin. The moment carried by the output shaft may be relatively large such that it imposes a force on the pin. The guides reduce the unsupported length of the pin and hence allow a smaller pin to be used and share the load with the casing. Further, the use of guides allows the characteristics of the system to be altered, and assists in isolating load and helps prevent the applied force from the output shaft from being transmitted to the connection between the pin and the arrestor path.

Preferably the movement of the pin is along a generally linear pin path. However, the pin may instead move along a generally curved pin path. The shape of the guideway will be dependent on the pin path and the intended rotation of the output shaft.

In preferred examples, the system includes one or more additional arrestor paths coupling the pin to the drive shaft such that rotation of the drive shaft results in movement of the pin along the pin path. In this case, in order for the system to provide an output, the coupling provided by each arrestor path to the pin must be such that the movement of the pin will be synchronised with the rotation of the output shaft. That is, the components in each arrestor path must continue to function as expected if the pin is to continue to move in the synchronised manner. If a failure occurs in any one of the arrestor paths, then movement of the pin may not be synchronised with the rotation of the output shaft, regardless of how the components in the other arrestor paths are functioning.

Where the system includes more than one arrestor path, each arrestor path may be provided with any of the features which have been described above in relation to systems having one arrestor path. The features of each arrestor path may be the same or different as the features of the other arrestor paths. For example, one arrestor path may include a leadscrew whilst another arrestor path may include a worm drive.

Where the system includes one or more arrestor paths, components of the system may be shared between arrestor paths. Sharing of components can minimise the complexity of the system as well as reducing cost and spacing requirements. However in some cases, it may be preferable for components of the system to be separately provided for each arrestor path. For example, where the system includes a self-locking means, it may be preferable for each arrestor path to be separately provided with a self-locking means. This has the advantage that if a self-locking means in one arrestor path becomes damaged such that in the event of a failure in the system the self-locking means cannot self-lock, then the self-locking means in the other arrestor path(s) can still self-lock and therefore prevent the pin from moving, and therefore prevent the undesired rotation of the output shaft.

Where the guideway is a through channel in the output shaft and where the pin projects completely through the channel, one arrestor path may couple to a first end of the pin and another arrestor paths may couple to a second end of the pin. Here, each arrestor path will couple the rotation of the drive shaft to the movement of their respective end of the pin. Therefore, for the movement of the pin to be synchronised with the rotation of the output shaft, the movement of the pin at both ends must be synchronised with respect to each other.

In a preferred example, two or more arrestor paths alternately engage with the pin such that the arrestor paths alternately couple the pin to the drive shaft. In this case, each arrestor path can be configured to cause the pin to move in a different direction to that caused by the other arrestor path such that when the drive shaft and the output shaft are rotating, the pin can move back and forth along the pin path. This is particularly useful for systems in which the drive shaft and output shaft are rotating by more than one complete turn.

The system may include one or more additional pins. Where there is more than one arrestor path, each pin may be coupled to the drive shaft by the one or more arrestor paths such that rotation of the drive shaft results in movement of each pin along its respective pin path. For the system to provide an output, the movement of each pin must be synchronised with the rotation of the output shaft.

Each additional pin may be individually associated with a respective guideway. Alternatively, two or more pins may be associated with the same guideway. For example, where the guideway is a through channel, one pin may project into the channel from a first end whilst a second pin projects into the channel from a second end.

The pin may be provided on a first rotatable member, the first rotatable member including a second guideway, and arranged such that rotation of the drive shaft results in rotation of the rotatable member, the pin and the second guideway. A second pin and the guideway associated with the output shaft may be provided on a second rotatable member, the second rotatable member being coupled to the output shaft such that rotation of the drive shaft results in rotation of the output shaft at the second rotatable member and the movement of said second pin along a second generally curved path. When the rotation of the first rotatable member is synchronised with the rotation of the second rotatable member the second pin moves along the second guideway and the pin coupled to the first rotatable member moves along the guideway associated with the second rotatable member. When the rotation of the first rotatable member is not synchronised with the rotation of the second rotatable member, the second pin abuts against the sidewall of the second guideway and the pin coupled to the first rotatable member abuts against the sidewall of the guideway of the second rotatable member to prevent the further rotation of the output shaft.

### BRIEF DESCRIPTION OF THE DRAWINGS

Embodiments of the invention will now be described by way of example only with reference to the accompanying drawings, in which:

FIG. 1 shows a schematic view of a first embodiment of a system having a rotary output having a rotary output;

FIG. 2 shows a side view of the system having a rotary output of FIG. 1;

FIG. 3 shows an end view of the system having a rotary output of FIG. 1;

FIG. 4 shows a schematic view of a second embodiment of a system having a rotary output;

FIG. 5 shows a side view of the system of FIG. 4;

FIG. 6 shows a plan view of a third embodiment of a system having a rotary output;

FIG. 7 shows a side view of a fourth embodiment of a system having a rotary output;

FIG. 8 shows a side view of a fifth embodiment of a system having a rotary output;

FIG. 9 shows a plan view of the system of FIG. 8;

FIG. 10 shows a plan view of a sixth embodiment of a system having a rotary output;

FIG. 11 shows an end view of a first ring gear and first upper and lower gears;

FIG. 12 shows a plan view of a seventh embodiment of a system having a rotary output.

### DETAILED DESCRIPTION

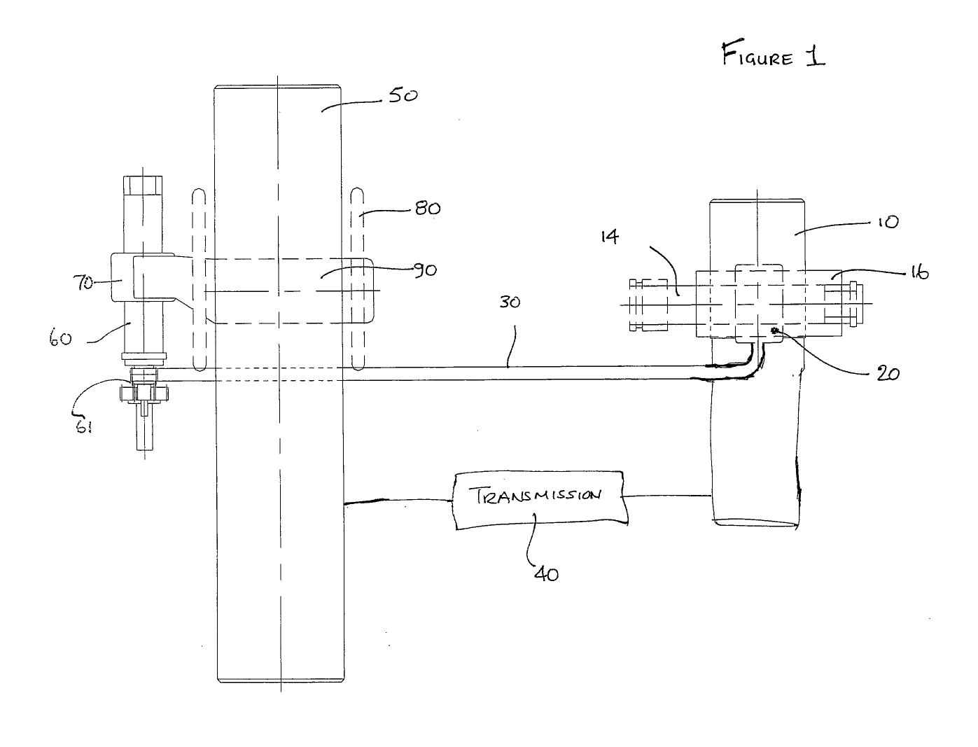

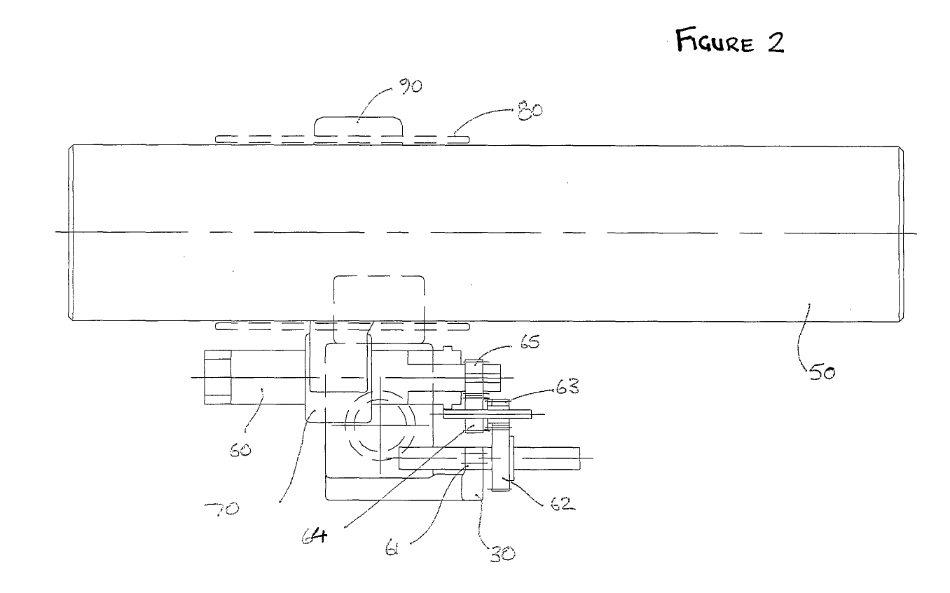

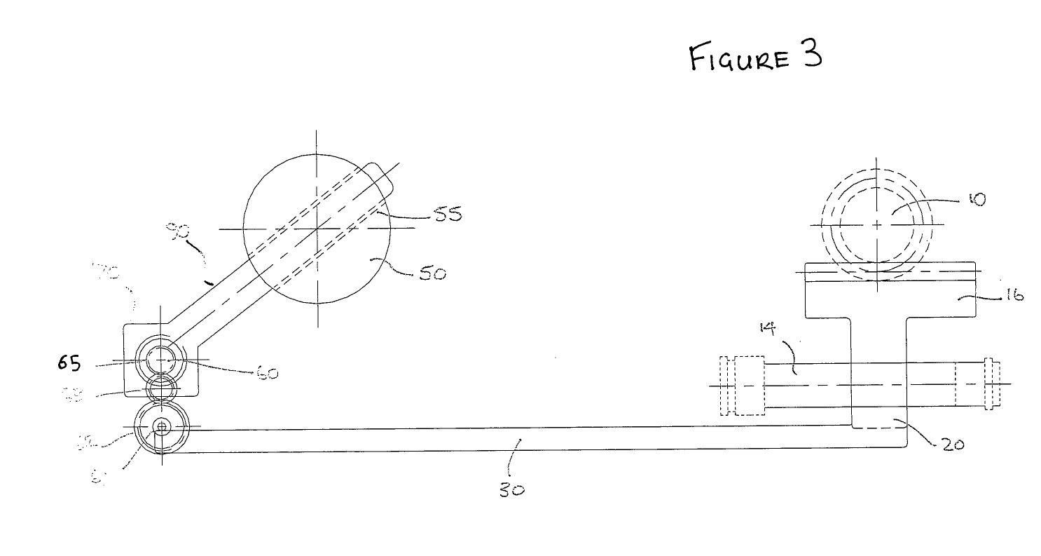

FIG. 1 shows a schematic view of a first embodiment of a system having a rotary output. FIG. 2 shows the system of FIG. 1 when viewed from the left hand side of FIG. 1. FIG. 3 shows the system of FIG. 1 when viewed from the lower side of FIG. 1.

In the first embodiment, there is a transmission path coupling a drive shaft 10 to an output shaft 50, via a transmission means 40. As shown in FIG. 1, the transmission means 40 is coupled to both the drive shaft 10 and the output shaft 50 such that rotation of the drive shaft 10 results in a proportional rotation of the output shaft 50. The transmission means 40 can be any arrangement of gears or other suitable components which can transmit the motion and force of the drive shaft 10 to the output shaft 50. The transmission means 40 can convert and/or modify the motion and force transmitted from the drive shaft 10 and apply that modified motion to the output shaft 50 as desired.

As can be seen in FIGS. 1 to 3, in addition to the transmission path, there is also an arrestor path. The arrestor path couples a pin 90 to the drive shaft 10 via an extension arm 30, such that rotation of the drive shaft 10 results in a proportional motion of the pin 90. In the example shown in FIG. 1, the pin 90 moves in a generally linear path. Both the rotation of the output shaft 50 and the generally linear movement of the pin 90 are related to the rotation of the drive shaft 10.

The pin 90 projects through/into a guideway 55 associated with the output shaft 50. The guideway is shown as a channel extending through the output shaft 50, but could be a slot formed in the output shaft 50, a projection from the output shaft 50 or formed in any other suitable manner.

The channel 55 is arranged such that rotation of the output shaft aligns a different portion of the channel with the pin's path. The particular geometry of the channel 55 is not shown in FIGS. 1 to 3 but could have, for example, a generally helical or curved diagonal profile. The geometry will depend upon the expected relationship between the movement of the pin and the rotation of the output shaft.

When the system is providing an expected rotary output, the pin 90 will move linearly along its path and the output shaft 50 will rotate. The linear movement of the pin 90 is synchronised with the rotation of the output shaft 50 such that as the output shaft 50 rotates, the portion of the channel 55 aligned with the pin's path corresponds with the position of the pin 90 for any given rotation of the drive shaft 10. For example, the system may be configured such that, when the output shaft 50 rotates, the pin 90 will remain generally equidistant from the opposed side surfaces of the channel 55, throughout the duration of its generally linear movement, and therefore does not contact the opposed side surfaces of the channel 55. To facilitate this, the geometry of the channel 55 should be appropriately configured, and the rotation of the shaft 50 and the linear movement of the pin 90 should be synchronised with respect to one another.

In order for the output shaft 50 to rotate and hence in order for the system to provide an output, the linear motion of the pin 90 must be synchronised with the rotational output of the shaft 50. When synchronised, the pin 90 moves along the channel 55 as the output shaft 50 rotates allowing the system to provide an output.

Synchronised movement of the pin 90 and the shaft 50 depends upon the components of the paths which drive them, namely, the arrestor path and the transmission path. For a system to continue to provide an expected output, the components of the transmission path and the components of the arrestor path must continue to act on the output shaft 50 and the pin 90 to keep these moving synchronously. If a component in the arrestor path or transmission path becomes damaged or worn, the relative motion of the pin 90 and output shaft 50 will no longer be synchronised.

When synchronisation is lost, the position of the pin 90 with respect to the location of the channel 55 will no longer be as expected/intended. In this case, continued motion of the pin 90 and/or the output shaft 50 will result in the pin being forced against a sidewall of the channel 55, limiting the further rotation of the output shaft 50. More specifically, the abutment between the pin 90 and the channel 55 will create a force, which opposes the motion of the output shaft 50 and prevents further rotation of the output shaft 50. The size of the force will be dependent upon the extent to which the system has lost synchronisation.

The ability of the system to arrest when the two paths come out of synchronisation means that failure of the system to perform as expected will result in the system being prevented from outputting an unexpected and/or undesired rotation. This failure does not necessarily have to be a complete failure of one or all of the components, but also includes situations where failure constitutes partial wear of a component in either path. The extent to which wear results in the system arresting will be dependent upon how finely calibrated the system is. For example, a system could be made more likely to arrest in the event of minor wear of a component, by narrowing the gap between the surface of the channel 55 and the pin 90. Here, a narrow gap would mean that only the slightest deviation from the expected motion of either the pin 90 or output shaft 50, would result in contact between the pin 90 and the surface of the channel 55 and hence the system arresting. Alternatively, providing a large gap between the surface of the channel 55 and the pin 90 means that minor, and in some cases insignificant, wear of a component would not alone cause the system to arrest but that cumulative or more significant wear or failure could.

In the particular example shown in FIGS. 1 to 3, the drive shaft 10 is meshed with a toothed section 16. The toothed section 16 is attached to or integral with a first end of an extension arm 30. The second end of the extension arm 30 is meshed with a gear 61 which is, through a series of further gears, meshed with a leadscrew 60. A nut 70 attached to the pin 90 is meshed with the leadscrew 60 such that the rotation of the leadscrew 60 causes the translation of the nut 70 and therefore the pin 90 in a direction generally parallel to the axis of the leadscrew 60. The particular arrangement of gears coupling the extension arm 30 and the leadscrew 60 will depend on the extent to which the motion of the extension arm 30 needs be converted into the linear motion of the pin 90 such that it is synchronised with the rotation of the output shaft 50. Other factors which influence the movement of the pin 90 and its synchronisation with the rotation of the output shaft may include the length of the leadscrew 60 and its thread pitch. It will be appreciated that in some cases a single gear located at one end of the leadscrew 60 can suitably couple the extension arm 30 and the leadscrew 60. Alternatively, the pin 90 may be directly attached to or integral with the second end or any other part of the extension arm 30.

The pin 90 projects into and through the channel 55 within the output shaft 50. However, it will be appreciated that the pin 90 need not necessarily project completely into the channel 55 but rather only partially into it.

The drive shaft 10 may itself directly provide the drive to the system. Alternatively or additionally, the drive shaft 10 may be directly or indirectly driven by a driving mechanism. In FIGS. 1 to 3 the driving mechanism is internal to the system and acts indirectly on the drive shaft 10. In this case, the toothed section 16 is attached to or integral with a nut 20 which is meshed to a leadscrew 14. The leadscrew 14 is driven by a driving mechanism, for example by an actuator. Here, linear movement caused in the toothed section 16 by the driven leadscrew 14 results in rotational movement of the drive shaft 10, and hence the driving means indirectly drives the drive shaft 10. It will be appreciated that the driving mechanism may be external to the system and act directly on the drive shaft 10 and in such a case the toothed section 16 may be supported by a shaft which acts to guide the extension arm.

Where the drive shaft 10 is meshed with the toothed section 16, the toothed section 16 moves linearly in proportion to the rotation of the drive shaft 10, and results in linear movement of the extension arm 30. The meshing of the second end of the extension arm 30 with the gear 61 will convert the linear movement of the arm 30 into rotational movement of the gear 61. Through the series of gears 61, 62, 63, and 65, the linear movement of the extension arm 30 is converted into rotational movement of the leadscrew 60. Since leadscrew 60 is meshed with nut 70, rotation of the leadscrew 60 causes linear movement of the nut 70 and hence linear movement of the pin 90 along the longitudinal axis of the leadscrew 60. If the movement of the pin 90 is synchronised with the rotation of the output shaft 50, the pin 90 will then move along its linear path, as the output shaft 50 rotates.

The use of a leadscrew 60 to which the pin 90 is threadingly attached results in the arrestor being self-locking. In particular, because the pin 90 is directly or indirectly threadingly engaged with the leadscrew 60, the pin 90 can only move linearly when the leadscrew 60 rotates. Therefore, the application of force to the pin 90 at the output of the arrestor path does not result in movement of the pin 90 and therefore does not allow movement of the output shaft 50. For example, if the pin 90 was abutting against a sidewall of a channel 55 in the output shaft 50, the output shaft could be applying a force to the pin 90. If the leadscrew 60 were merely a track on which the nut 70 and pin 90 were slidably engaged, the force imposed on the pin 90 by the output shaft 50 could cause the pin 90 to slide along the track and hence allow the output shaft 50 to rotate, even if a failure had occurred within the system. However, since the nut 70 is threadingly engaged with a self-locking means such as the leadscrew 60, the nut 70 and pin 90 cannot be moved longitudinally by the force from the output shaft 50, since movement of the nut 70 and pin 90 can only be achieved through rotation of the leadscrew 60. Therefore, when a failure occurs within the system such that the motions of the pin 90 and output shaft 50 are not synchronised, even if the pin 90 is subject to a force, the pin 90 will not move along its linear path as a result of the force, hence the output shaft 50 will not be able to rotate and the system will remain arrested.

As can be seen in FIG. 1, at least a portion of the pin 90 projects into a guide 80, which is fixed with respect to the pin's path. In this example, the guide 80 is a channel of a casing housing the system. The guide 80 acts as a means for guiding the pin 90 along its path of travel, as well as helping to prevent the pin 90 from being moved out of the pin path, for example due to rotation of the output shaft 50. For example, where the output shaft 50 is rotating but is not synchronised with the movement of the pin 90 the side walls of the channel 55 will abut against the pin 90. The moment carried by the output shaft 50 may be relatively large such that it imposes a force on the pin 90. The guides 80 reduce the unsupported length of the pin 90 and hence allow a smaller pin to be used and share the load with the casing. Further, the use of guides 80 allows the characteristics of the system to be altered, and assist in isolating load and help prevent the applied force from the output shaft 5 from being transmitted to the connection between the pin 90 and the arrestor path.

As with the channel 55, the width of the guide 80, and hence the gap/distance between its surfaces and the surface of the pin 90 can be varied. Small gaps or distances would mean that only the slightest change in the expected motion or angle of the pin 90 would result in contact between the surfaces. A further means for arresting the system in the event of a failure is to form or coat the surfaces of the guide 80 with a material which is softer than the pin 90 such that it can be deformed by the pin 90, but which is sufficiently strong such that the deformed guide 80 will act to inhibit the movement of the pin 90 and thereby assist in arresting the system.

In addition to being able to prevent the output shaft 50 from rotating when the transmission path and the arrestor path are out of sync, the arrestor can be used to prevent the output shaft 50 from rotating beyond a certain range. This can be achieved by limiting the extent of the pin path. The extent of the pin path can be limited by, for example, limiting the length of the channel 55, by limiting the length of the leadscrew 60 or by limiting the amount of linear motion the arrestor path is able to provide the pin 90 with.

FIGS. 1 to 3 show a rotating system which has one arrestor path for preventing rotation when the system is failing to perform as expected. However, in other embodiments, the rotating system may have more than one arrestor path for arresting the rotation of the system. Where a rotating system includes more than one arrestor path, in order for the system to operate correctly and provide output, each arrestor path must be itself synchronised with respect to the transmission path and accordingly synchronised with respect to each other.

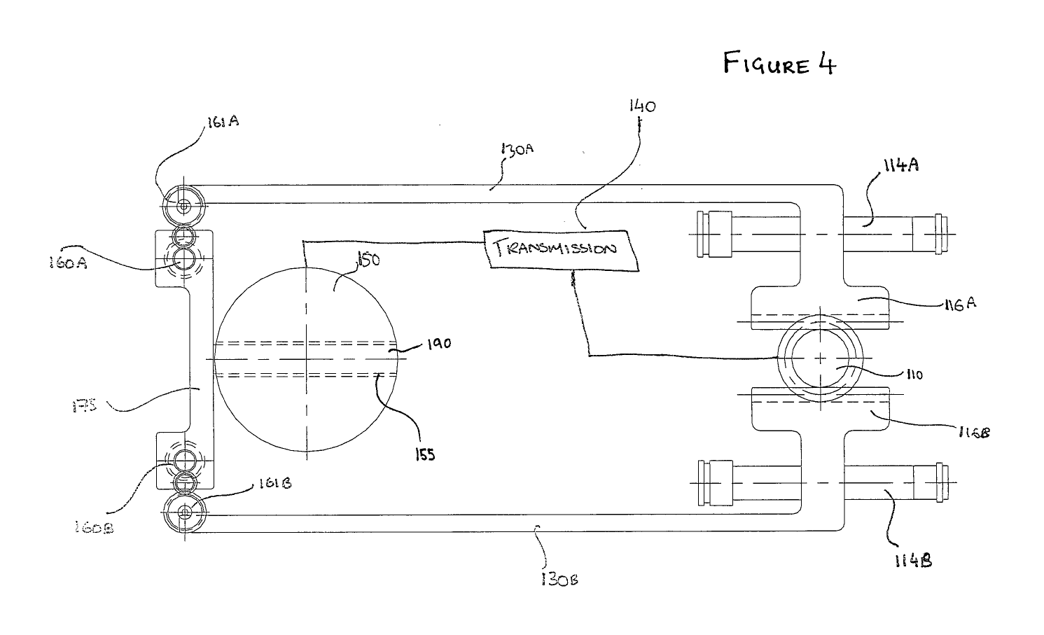

FIG. 4 shows a schematic view of a second embodiment of a system having a rotary output. The rotating system shown is similar to that shown in FIG. 1, but with the notable exception that the system of FIG. 4 includes a second arrestor path.

More specifically, the drive shaft 110 is meshed with and rotated with respect to first and second toothed sections 116A, 116B. The first and second toothed sections 116A, 116B are integral with or attached to respective first and second extension arms 130A, 130B, which are in turn meshed with respective first and second gears 161A, 161B. The first gear 161A is coupled, via a series of gears, to a first leadscrew 160A, which is in turn meshed with a first nut 170A. The second gear 161B is coupled, via a series of gears, to a second leadscrew 160B, which is in turn meshed with a second nut 170B. However, it will be appreciated that the first and second gears 161A, 161B may instead be located at one end of their respective leadscrews 160A, 160B without needing to be meshed to their respective leadscrews 160A, 160B via a series of gears.

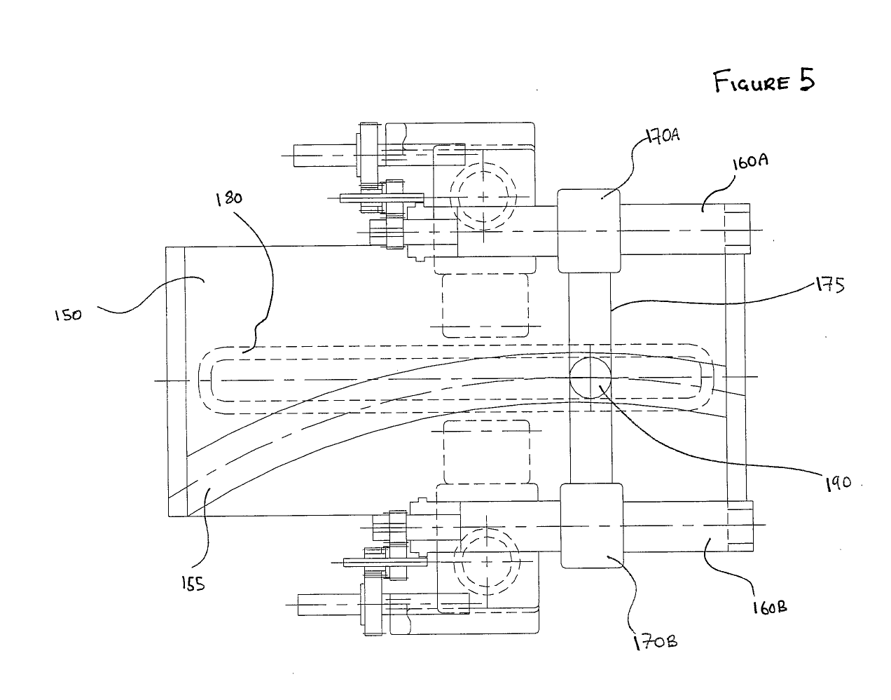

FIG. 5 shows a side view of the system of FIG. 4. As best seen in FIG. 5, an elongated span member 175 couples the first nut 170A to the second nut 170B. In particular, the first end of the elongated span member 175 is attached to or integral with the first nut 170A, whilst the second end of the elongated member 175 is attached to or integral with the second nut 170B. A pin 190 is attached to or integral with the span member 175. The pin 190 projects into/through a channel 155 or other guideways within an output shaft 150 as described with respect to the first embodiment. As in the first embodiment, the pin 190 can also project into a guide 80 which is fixed with respect to and generally aligned with the pin path.

In the example shown in FIGS. 4 and 5, the channel 155 has a generally curved diagonal profile. However, for this or any other embodiment, the channel 155 could have any other suitable profile which would allow the pin 190 to move as expected along the pin path as the shaft 150 is rotated. The profile of the channel 155 is dependent on the particular pin path and the intended rotation of the output shaft 50. For example, the channel 155 could be helical or s-shaped, a straight or curved diagonal, or a parabola or combinations thereof.

As with the earlier embodiment, the transmission path includes a transmission means 140 which is coupled to both the drive shaft 110 and the output shaft 150 such that rotation of the drive shaft 110 results in rotation of the output shaft 150. The transmission means 140 may be an arrangement of gears or other suitable components, which can convert and modify the motion/force transmitted from the drive shaft 110 as desired, and which can apply that modified motion/force to the output shaft 150.

For the system to provide an expected rotary output, the linear movement of the pin 190 must be synchronised with the rotation of the output shaft 150 such the portion of the channel 155 aligned with the path corresponds with the position of the pin 190, for any given rotation of the drive shaft 110. However, if the two motions are not synchronised, for example due to a failure of a component in the transmission means 140, the portion of the guideway 155 aligned with the path will not correspond with the position of the pin 190 such that the pin will abut against a sidewall of the channel 155 to limit the further rotation of the output shaft 150.

In the embodiment shown in FIGS. 4 and 5, the first toothed section 116A meshes to a radially opposite surface of the drive shaft 110 to that of the second toothed section 116B. Accordingly, rotation of the drive shaft 110 results in the toothed sections 116A, 1166 and their corresponding extension arms 130A, 130B being driven in linearly opposite directions. Therefore for example, it may be that to ensure that both nuts 170A, 1706 are being driven in the same direction, either one of the arrestor paths may be provided with an additional gear, or one of the leadscrews 160A, 160B may be provided with a clockwise thread, whilst the other is provided with an anti-clockwise thread and/or the relative position and configuration of the arms 130A and 130B can be arranged to provide the necessary operational output.

If the leadscrews 160A, 160B drive the respective nuts 170A, 170B at a different rate, the span member 175 will twist so that it is no longer perpendicular to the leadscrews 160A, 160B. This will cause the nuts 170A, 170B to jam onto the thread of the leadscrews 160A, 160B. Therefore, in the event of any wear or damage in one of the two arrestor paths, the movement of the nuts 170A, 170B will vary causing the nuts 170A, 170B to lock in place, preventing movement of the pin 190 and therefore preventing further rotation of the output shaft 150, arresting the system.

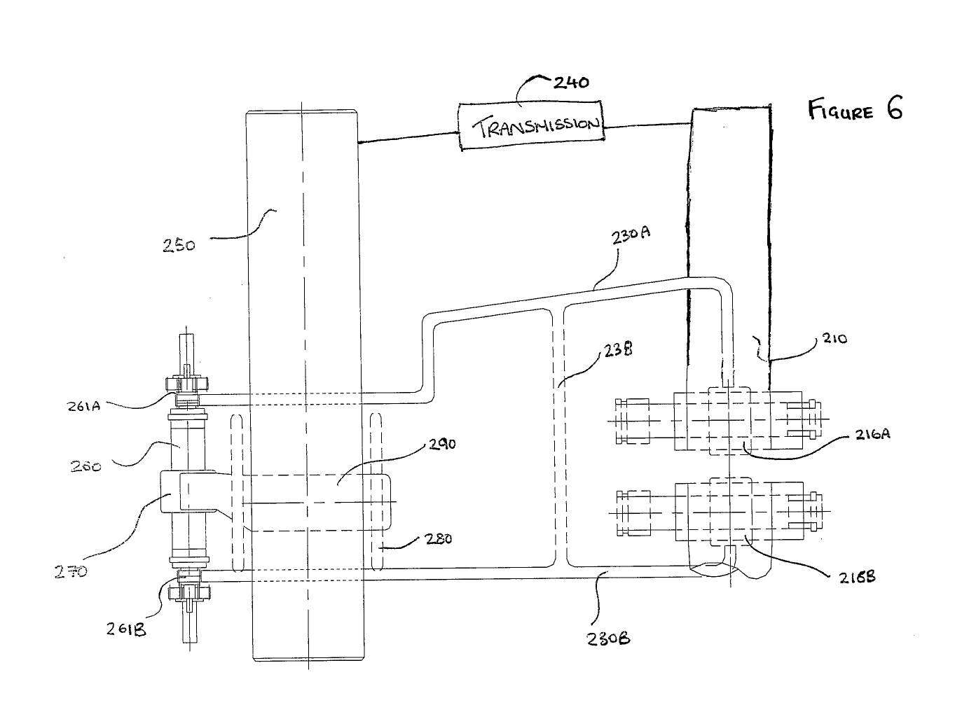

FIG. 6 shows a plan view of a third embodiment of a system having a rotary output. In this embodiment, there is a first arrestor path and a second arrestor path. In this embodiment, the arrestor paths share a component, namely a leadscrew 260. A first extension arm 230A of the first arrestor path meshes with a first gear 261A located at a first end of the leadscrew 260, whilst a second extension arm 230B of the second arrestor path meshes with a second gear 261B located at a second end of the leadscrew 260. A nut 270 integral with or attached to a pin 290 is meshed with the thread of the leadscrew 260 and operates as described with respect to the first embodiment.

If the movement of the two arrestor paths is not synchronised, such that a different driving force is applied to the opposite ends of the leadscrew 260, the leadscrew 260 will not rotate and therefore the pin 290 will not move, thereby preventing rotation of the output shaft 250 due to the abutment of the stationary pin 290 with the sidewall of the channel.

An optional bridge member is provided between the first and second extension arms 230A, 230B. In the example shown in FIG. 6, the bridge member is a flexible bridge member 238 which is expandable and retractable. For example, the flexible bridge member 238 could be a telescopic member or could be elastic. Such a bridge member 238 permits movement of the arms 230A, 230B in the same direction as each another, and permits movement of the arms 230A, 230B in the opposite direction to each other. However, when the arms 230A, 230B are moving in the opposite direction to each other, the bridge member will act to limit the extent of their movement.

It will be appreciated that the bridge member could instead be a rigid bridge member which would help strengthen the structural rigidity of the arms 230A, 230B when they are moving in the same linear direction, and which would prevent the arms 230A, 230B from moving in opposite directions to one another.

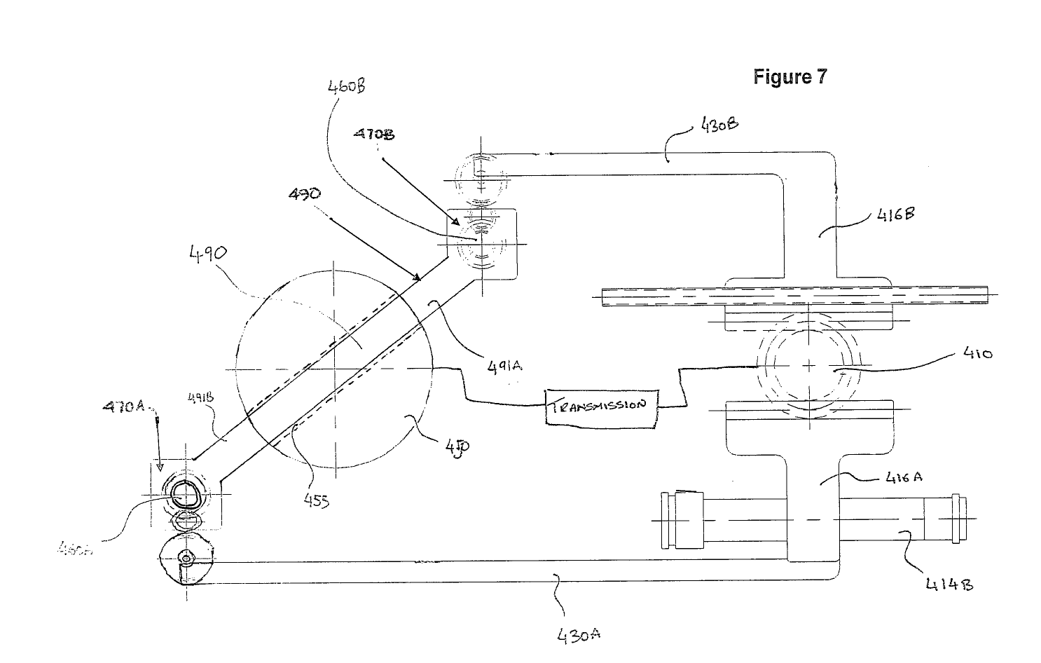

FIG. 7 shows a side view of a fourth embodiment of a system having a rotary output. In this embodiment the guideway is a channel 455 extending through the output shaft 450. The pin 490 projects completely through the channel 455 in the output shaft 450, and is attached to or integral with a first nut 470A at its first end 491A, and attached to or integral with a second nut 470B at its second end 491B. Each nut 470A, 470B is meshed with its own respective leadscrew 460A, 460B. Each end of the pin 491A, 491B is coupled to the drive shaft 410 by a different arrestor path. Namely, the first end of the pin 491A is coupled to the drive shaft 410 via the first arrestor path, and the second end of the pin 491B is coupled to the drive shaft 410 via the second arrestor path, such that rotation of the drive shaft 410 results in movement of each end of the pin 490.

In order for the system to provide an expected rotary output, the movement of both ends of the pin 491A, 491B must be synchronised with the rotational motion of the output shaft 450 such that the pin 490 will move along its pin path and the output shaft will rotate, without the pin 490 abutting against a sidewall of the channel 455. Since the movement of each end of the pin 491A, 491B is governed by their respective arrestor path, both arrestor paths must be synchronised with the rotation of the output shaft 455 in order for the system to provide an output.

In the example shown in FIG. 7, the inputs of both arrestor paths are directly coupled to the drive shaft 410 via respective toothed sections 416A, 416B with the arrestor path functioning generally as described with respect to the first embodiment. However, one or both of the arrestor paths may instead receive an input from another component within the system such that the arrestor path is indirectly coupled to the drive shaft 410. For example, the system could be configured such that the second arrestor path receives an input from a component within the transmission means 440, for example a rotating gear.

Rotation of the drive shaft causes rotation of the rotating gear to which the second arrestor path is coupled and therefore the second arrestor path is indirectly coupled to the drive shaft 410.

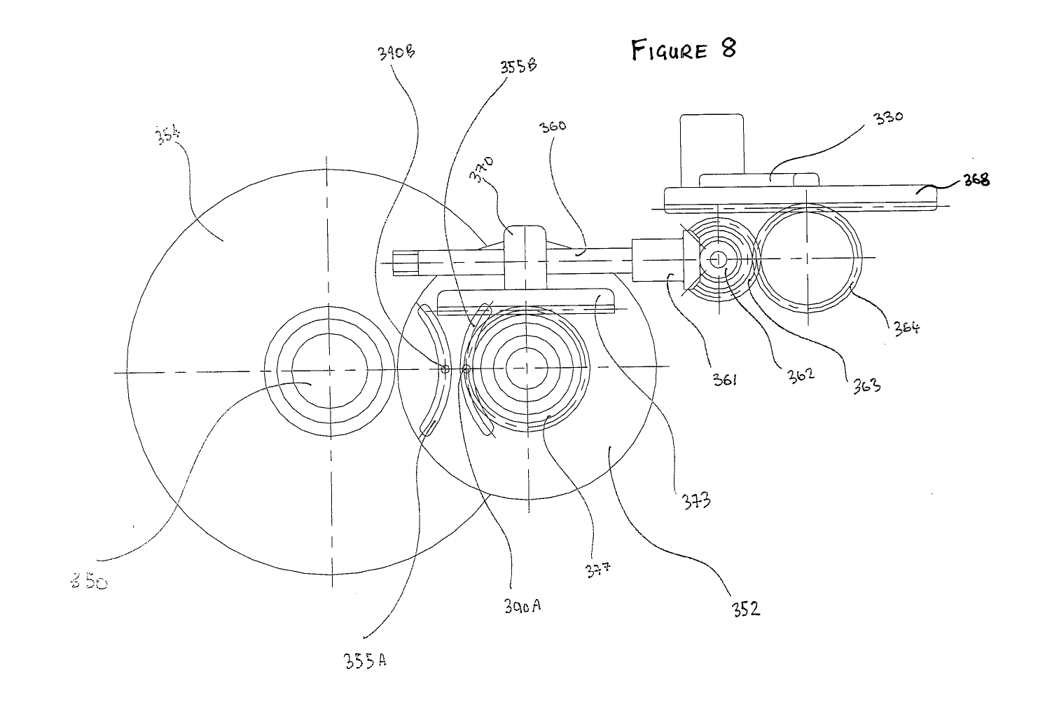

FIG. 8 shows a fifth embodiment of a system. In this embodiment, there is an arrestor path, having an extension arm 330. The extension arm 330 is meshed to a drive shaft in a manner similar to that which has been described with regards to the previous embodiments. The extension arm 330 is meshed, via a toothed rack 368 and a series of gears 361, 362, 363, 364 to a leadscrew 360. A nut 370 is meshed to the thread of the leadscrew 360. The nut 370 is attached to or integral with a toothed member 373, which is meshed with a gear 377. The gear 377 is attached to or integral with a first disc 352, having a first pin 390A and a second channel 355A. The first pin 390A projects into a first channel 355B on a second disc 354. The second disc 354 lies on a plane generally parallel to the first disc and includes a second pin 390B which projects into the second channel 355A of the first disc 352.

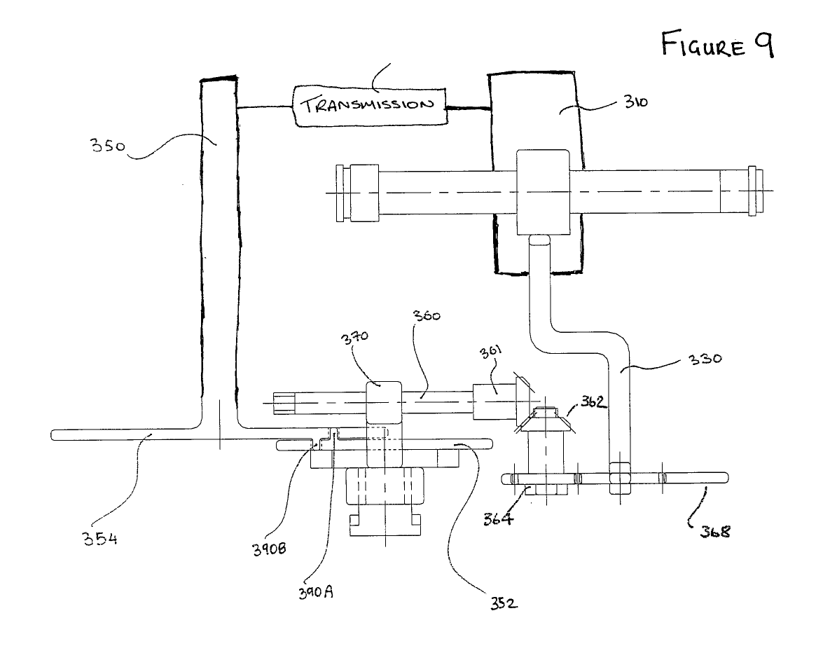

FIG. 9 shows a plan view of the system of FIG. 8. As can be seen from FIG. 9, the second disc 354 is coupled to the output shaft 350 such that when the output shaft 350 rotates, the second disc 354 rotates. It will be appreciated that the second disc 354 may also be integral with the output shaft 350.

As with the other embodiments, a transmission path couples the drive shaft 310 to the output shaft 350 via transmission means 340 such that rotation of the drive shaft 310 results in rotation of the output shaft 350.

In the arrestor path, rotation of the drive shaft 310 results in linear movement of the extension arm 330 from left to right and from right to left in FIG. 9. This results in linear movement of the toothed rack 368 and in turn rotation of the gears 361, 362, 363, 364 which in turn results in rotation of the leadscrew 360. The rotation of leadscrew causes the nut 370 to move linearly and hence the gear 377 and first disc 352 to rotate.

When the system is providing an expected/desired rotary output, the rotational movement of the discs 352, 354 will be synchronised with respect to one another such that the first and second pins 390A, 390B move along the respective channels 355B, 355A. If the rotations of the discs 352, 354 is not synchronised, then the first and second pins 390A, 390B will abut against the sidewalls of their respective channels 355B, 355A jamming the discs 352, 354 and thereby limiting the further rotation of the discs 352,354 and hence the further rotation of the output shaft 350.

In addition to being synchronised, for the system shown in FIGS. 8 and 9 to provide an expected rotary output, the discs 352, 354 must rotate in opposite directions to each other. This does not limit each disc 352, 354 to only one direction of rotation, but rather requires that when one disc is rotating in one direction, the other disc will be rotating in the opposite direction. For example, where the first disc rotates in a clockwise direction, the second disc will rotate in an anti-clockwise direction, and vice versa. If the discs 352, 354 rotate in the same direction then, or rotate out of synchronisation, the geometry of the channels 355A, 355B will result in the first and second pins 390A, 390B abutting against the sidewalls of their respective channel 355B, 355A and hence inhibiting rotation of the discs 352, 354.

It will be appreciated that the amount of rotation of the discs 352, 354 and therefore the amount of rotation of the output shaft 350 is limited by the limit of movement of the pins 390A, 390B at the closed ends of the channels 355B, 355A.

In the example shown in FIGS. 8 and 9, the extension arm 330 is coupled to the first disc 352 via the leadscrew 360, and a series of gears. The particular arrangement chosen will depend on the extent to which the motion of the extension arm 330 needs be converted into rotational motion in the first disc 352 in order for rotation of the first disc 352 to be synchronised with rotation of the second disc 354 and/or the relative position of the drive shaft 310 with respect to the first disc. However, it will be appreciated that in some cases a single gear located at one end of the leadscrew 360 can suitably couple the extension arm 330 and the leadscrew 360.

It will be appreciated that the first and second disks need not be circular, but could be any other desired shape.

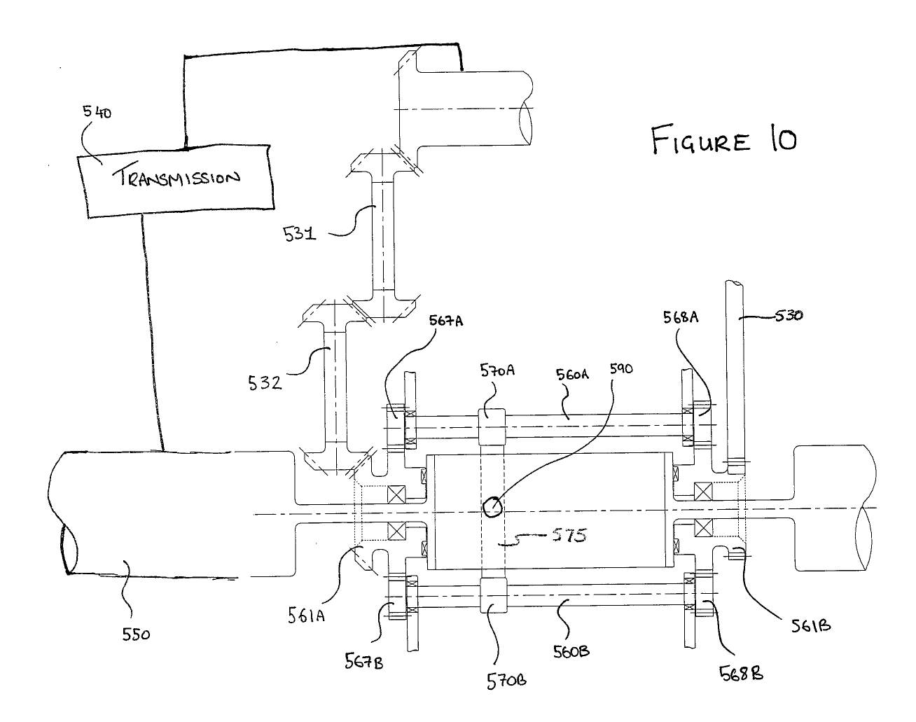

FIG. 10 shows a plan view of a sixth embodiment of a system having a rotary output. As with the previous embodiments, there is a transmission path comprising a transmission means 540 coupling the drive shaft 510 to the output shaft 550 such that rotation of the drive shaft 510 results in rotation of the output shaft 550.

In addition to the transmission path, the system includes two arrestor paths, only one of which is shown in its entirety in FIG. 10. In the first arrestor path, as shown in FIG. 10, rotation of the drive shaft 510 results in rotation of intermediate shafts 531, 532 coupled via bevelled gears which in turn result in rotation of first ring gear 561A. The output shaft 550 passes through the first ring gear 561A without directly coupling their rotations.

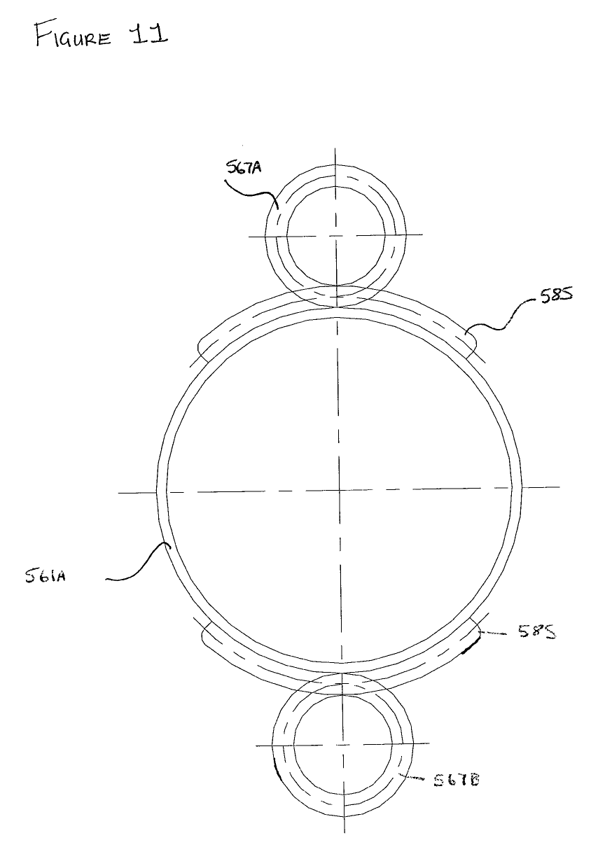

The first ring gear 561A is partially meshed with a first upper gear 567A and a first lower gear 567B. This can be best seen in FIG. 11 which shows an end view of the first ring gear 561A and the first upper and lower gears 567A, 567B. The first upper and lower gears 567A, 567B are coupled to first endpoints of respective upper 560A and lower 560B leadscrews. The threads of the upper and lower leadscrews 560A, 560B are meshed with respective upper and lower nuts 570A, 560B. In a similar manner to that shown in FIG. 5, an elongated span member 575 couples the first nut 570A to the second nut 570B. A pin 590 is attached to or integral with the span member 575 and projects into a channel 555 in the output shaft 550. Therefore, when the toothed sections 585 are meshed with the first upper and lower gears 567A, 567B, rotation of the first ring gear 561A will result in rotation of the leadscrews 560A, 560B and hence linear movement of the pin 590.

As can be seen in FIG. 11, the first ring gear 561A is partially meshed with the upper and lower gears 567A, 567B via first and second toothed sections 585. The toothed sections 585 are located on radially opposite portions of the first ring gear's 561A outer surface and each occupy around a quarter of the first ring gear's 561A circumference. Therefore, when the first ring gear 561A is rotating continuously, the toothed sections 585 will alternately mesh with the first upper and lower gears 567A, 567B for approximately 90 degrees of rotation at a time.

In this embodiment, the first arrestor path is calibrated such that the toothed sections 585 engage with the first upper and lower gears 567A, 567B when the nuts 570A, 570B are located at one end of their respective leadscrew 560A, 560B and disengage with the first upper and lower gears 567A, 567B when the nuts 570A, 57B reach the other end of their respective leadscrew 560A, 560B.

In addition to the first arrestor path, there is a second arrestor path. The second arrestor path includes an extension arm 530 which is coupled to the drive shaft 510 such that rotation of the drive shaft 510 results in linear movement of the extension arm 530. The extension arm 530 is meshed to a second ring gear 561B such that the linear movement of the extension arm 530 results in rotation of the second ring gear 561B.

The second ring gear 561B is partially meshed with second upper and lower gears 568A, 568B via first and second toothed sections of the second ring gear 561B. The toothed sections of the second ring gear 561B are generally the same as those on the first ring gear 561A, but are angularly offset to correspond to the gaps between the toothed sections 585 of the first ring gear 561A. In this way, the toothed sections of the second ring gear 561B engage with respective second upper and lower gears 568A, 568B when the nuts 570A, 570B are located at one end of their respective leadscrew 560A, 560B and disengage with the first upper and lower gears 567A, 567B when the nuts 570A, 57B reach the other end of their respective leadscrew 560A, 560B.

The first and second arrestor paths are arranged such that when the first ring gear 561A is engaged with the first upper and/or lower gears 567A, 567B, the second ring gear is not engaged with the second upper and/or lower ring gears 568A, 568B, but when the second ring gear 561B is engaged with the second upper and/or lower gears 568A, 568B, the first ring gear 561A is not engaged with the first upper and/or lower ring gears 567A, 567B

The first and second arrestor paths are arranged such that the first ring gear 561A causes linear movement of the pin 590 in a first direction whilst the second ring gear 561B causes linear movement of the pin 590 in a second direction which is opposite to the first direction. For example, the first ring gear 561A can rotate in the opposite direction to that of the second ring gear 561B. In this case, when the toothed sections 585 of the first ring gear 561A are engaged with the first upper and lower gears 567A, 567B the leadscrews 560A, 560B will rotate and hence cause linear movement of the pin 590 in the first direction.

After a certain amount of rotation of the first ring gear 561A, its toothed sections 585 will disengage from the first gears 567A, 567B and no longer cause rotation of the leadscrews and hence movement of the pin 590 in the first direction. At this point, the toothed sections 587 of the second ring gear will become meshed with the second upper and lower gears 568A, 568B and hence cause rotation of the leadscrews 560A, 560B. Since the second ring 561B gear rotates in the opposite direction to that of the first ring gear 561A, rotation of the second ring gear 561B will now cause the pin 590 to move linearly in the second direction which is opposite to the first direction.

When the system is providing an expected rotary output, the first ring gear 561A, when coupled to the pin 590, will cause linear movement of the pin in a first direction and the second ring gear 561B, when coupled to the pin 590, will cause linear movement of the pin in a second direction which is opposite to the first direction. Since only one of the first and second ring gears 561A, 561B can be coupled to the pin 590 at any one point in these formats and since the first and second ring gears 561A, 561B will couple to the pin 590 in alternating periods, continuous rotation of the first and second ring gears 561A, 561B results in the pin moving back and forth along its linear pin path.

When the system is providing an expected output, the linear motion of the pin 590 will be synchronised with the rotational output of the shaft 550. That is, the linear movement of the pin 590 will be synchronised with the rotational movement of the shaft 550 such that the portion of the channel 555 aligned with the pin's path corresponds with the position of the pin, for any given rotation of the drive shaft 510. Since both arrestor paths drive the linear motion of the pin 590, both arrestor paths will be synchronised with respect to the rotation of the output shaft and hence each other. In particular, the movement of the pin 590 back and forth along its linear path is dependent upon the arrestor paths being configured such that when one of the ring gears 561A, 561B is engaged with the leadscrews 560A, 560B and causing movement of the pin 590, the other ring gear is not engaged with the leadscrews 560A, 560B and hence is not causing movement of the pin 590 in these formats. However, if there is a failure in one of the arrestor paths, such that it is no longer operating as expected, the arrestor path may begin to cause its ring gear engage with the respective upper and lower gears and therefore leadscrews 560A, 560B at points in which the other ring gear is engaged with the respective upper and lower gears and leadscrews 560A, 560B. In this case the first ring gear 561A could engage with the leadscrews 560A, 560B whilst the second ring gear 561B is engaged with the leadscrews 560A, 560B. Since the ring gears are rotating in different directions, each ring gear would be applying opposing rotational forces to the ends of the leadscrews 560A, 560B. Therefore, the leadscrews 560A, 560B would jam and hence the pin 590 would no longer move along its linear path, thereby preventing any further rotation of the output shaft 550.

Likewise, if a failure occurred in the transmission path, such that it was no longer operating as expected, the output shaft 550 would no longer rotate as expected. In such a case, synchronisation between the rotation of the output shaft 550 and the linear movement of the pin 590 would be lost. If the motions of the pin 590 and the output shaft 550 are out of sync, the portion of the guideway aligned with the path will not correspond with the position of the pin such that the pin will abut against a sidewall of the guideway and limit the further rotation of the output shaft.

When the system is providing an expected rotary output, the pin 590 will move back and forth along the channel and the output shaft 550 will rotate. In the embodiment shown in FIG. 10, the output shaft rotates continuously and therefore the channel is provided with an appropriate profile such that the output shaft 550 will rotate and the pin 590 will move back and forth along the channel without the pin abutting against a sidewall of the channel 555. For example, the channel 555 could be a continuous channel such that its endpoints connect to form a continuous loop arrangement.

Although FIG. 10 shows two leadscrews each driving a nut with a span member between supporting the pin (in a similar manner as shown in FIG. 5), it will be appreciated that a single leadscrew could be used with a single nut and associated pin (in a similar manner to that shown in FIGS. 1 to 3).

It will also be appreciated that the ring gears could include fewer or more toothed sections provided the toothed sections on the two ring gears are offset from each other, and, where two or more leadscrews are provided that these are each driven synchronously.

FIG. 10 shows two arrestor paths, namely a first arrestor path on the left hand-side of the figure driving the first ring gear 561A and a second arrestor path on the right hand-side of the figure driving the second ring gear 561B. However, it will be appreciated that the left hand-side of the figure could instead include one or more arrestor paths to drive the first ring gear 561A. Alternatively or additionally, the right hand-side of the Figure could include one or more arrestor paths to drive the second ring gear 561B. The arrestor paths on either side of the Figure could include any appropriate arrangement of gears, bevelled gears or any other suitable components such that rotation of the drive shaft 510 results in movement of the pin 590.

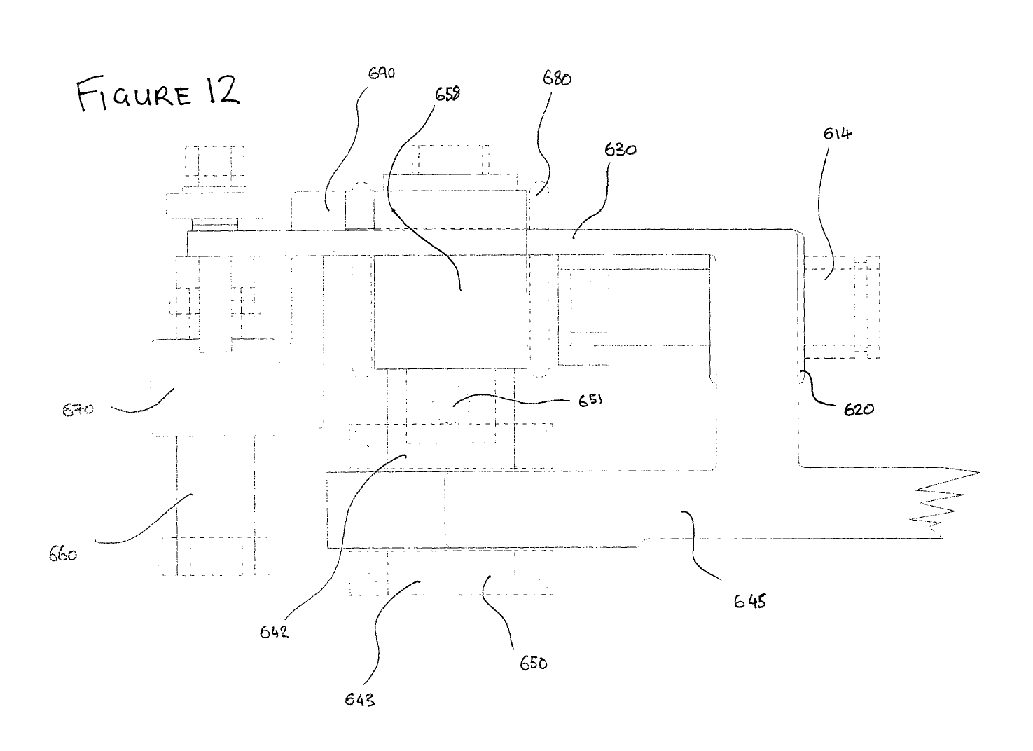

FIG. 12 shows a plan view of a seventh embodiment of a system having a rotary output. In this embodiment, the drive shaft 614 and the output shaft 650 are located such that their longitudinal axes are perpendicular with respect to one another. It will therefore be appreciated that the present invention embodies rotating systems in which the drive shaft and the output shaft have different orientations with respect to one another.

FIG. 12 shows one way in which the transmission path can couple the drive shaft 614 to the output shaft 650 such that rotation of the drive shaft 10 results in rotation of the output shaft 50. In this embodiment, the drive shaft 610 is a leadscrew. The thread of the drive shaft 610 is meshed with a nut 620. The nut 620 is attached to or integral with an extension arm 630 such that rotation of the drive shaft 610 results in movement of the extension arm 630. One end of the extension arm 630 meshes directly with at least one gear located at one end of a leadscrew 660. Therefore, rotation of the drive shaft 610 result in rotation of the leadscrew 660, via the linear movement of the extension arm 630.

A nut 670 is attached to or integral with a pin 690. The nut 670 is meshed with the thread of the leadscrew 660 such that rotation of the leadscrew 660 results in linear movement of the nut 670 and the pin 690. Therefore, rotation of the drive shaft 610 results in proportional linear movement of the pin 690 via the extension arm 630 and the leadscrew 660.

The pin 690 projects into a channel 655 in a rotatable shaft 658. The rotatable shaft 658 is coupled to the output shaft 650 via a connecting means 651, such that rotation of the output shaft 650 results in rotation of the rotatable shaft 658, and hence rotation of the channel 655.

In the example shown in FIG. 12, the transmission path includes a transmission arm 645 which is attached to or integral with the extension arm 630. Therefore, as with the extension arm 630, rotation of the drive shaft 610 results in linear movement of the transmission arm 645. One end of the transmission arm 645 meshes with at least one of the gears 642. The gear 642 is attached to or integral with the output shaft 650 such that linear movement of the transmission arm 645 results in rotation of the output shaft 650. Since the output shaft 650 is coupled to the rotatable shaft 658, rotation of the output shaft 650 results rotation of the rotatable shaft 658. Therefore, when the drive shaft 610 is driven such that it rotates, rotation of the drive shaft 610 will result in a proportional linear movement of the pin 690 and proportional rotation of the rotatable shaft 658 and channel 655.

When the system is providing an expected output, the pin 690 moves along the channel 655 and the output shaft 650 and the rotatable shaft 658 rotate. That is, the linear movement of the pin 690 is synchronised with the rotation of the output shaft 650 such that as the output shaft 650 rotates, at least a portion of the channel 655 corresponds with the position of the pin 690 for any linear movement of the pin 690 and/or rotation of the output/rotatable shaft 650/658.

1. A system having a rotary output, the system comprising:
a drive shaft;
an arrestor path coupling a pin to the drive shaft such that rotation of the drive shaft results in movement of the pin along a pin path;
an output shaft providing output from the system or coupled to a shaft which provides output from the system, the output shaft associated with a guideway arranged such that rotation of the output shaft aligns a different portion of the guideway with the pin path; and
a transmission path coupling the drive shaft to the output shaft such that rotation of the drive shaft results in rotation of the output shaft; and
wherein when the movement of the pin is synchronised with the rotation of the output shaft, the portion of the guideway aligned with the pin path corresponds with the position of the pin, for any given rotation of the drive shaft;
wherein when the movement of the pin is not synchronised with the rotation of the output shaft, the portion of the guideway aligned with the pin path will not correspond with the position of the pin such that the pin will abut against a sidewall of the guideway to limit the further rotation of the output shaft.

2. A system having a rotary output according to claim 1, wherein rotation of the drive shaft results in proportional rotation of the output shaft.

3. A system having a rotary output according to claim 1, wherein the system is self-locking.

4. A system having a rotary output according to claim 3, wherein the self-locking means comprises a leadscrew which is directly or indirectly threadingly engaging with the pin such that rotation of the leadscrew results in movement of the pin along the pin path.

5. A system having a rotary output according to claim 1, wherein the guideway comprises a channel.

6. A system having a rotary output according to claim 5, wherein the channel comprises a blind channel which projects partially into the output shaft.

7. A system having a rotary output according to claim 5, wherein the channel comprises a through channel which projects completely through the output shaft.

8. A system having a rotary output according to claim 7, wherein the pin projects completely through and beyond the channel in the output shaft.

9. A system having a rotary output according to claim 1, wherein the pin projects into/through a guide which is generally aligned line with the pin path and which is fixed with respect to the pin path.

10. A system having a rotary output according to claim 9, wherein the guide is integral with a casing housing the system having a rotary output.

11. A system having a rotary output according to claim 1, further comprising one or more additional arrestor paths coupling the pin to the drive shaft such that rotation of the drive shaft results in movement of the pin along the pin path.

12. A system having a rotary output according to claim 11, wherein components of the system are shared by the arrestor paths.

13. A system having a rotary output according to claim 11, wherein each arrestor path is self-locking.

14. A system having a rotary output according to claim 11, wherein one arrestor path couples to a first end of the pin and another arrestor path couples to a second end of the pin such that when the movement of the pin is synchronised with the rotation of the output shaft, both ends of the pin move together.

15. A system having a rotary output according to claim 1, wherein two or more arrestor paths alternately engage with the pin such that the arrestor paths alternately couple the pin to the drive shaft such that rotation of the drive shaft results in movement of the pin along the pin path.

16. A system according to claim 11, further comprising one or more additional pins.

17. A system of claim 16, wherein each arrestor path separately couples the drive shaft to a respective pin such that rotation of the drive shaft results in movement of the respective arrestor path's pin along its respective pin path.

18. A system according to claim 1, wherein the pin path is generally linear.

19. A system according to claim 1, wherein the pin path is generally curved.

20. A system according to claim 19, wherein:
the pin is provided on a first rotatable member, the first rotatable member including a second guideway, and arranged such that rotation of the drive shaft results in rotation of the rotatable member, the pin and the second guideway; and
wherein when the rotation of the first rotatable member is synchronised with the rotation of the second rotatable member the second pin moves along the second guideway and the pin coupled to the first rotatable member moves along the guideway associated with the second rotatable member; and
wherein when the rotation of the first rotatable member is not synchronised with the rotation of the second rotatable member, the second pin abuts against the sidewalls of the second guideway and the pin coupled to the first rotatable member abuts against the sidewalls of the guideway of the second rotatable member to prevent the further rotation of the output shaft.
